(19) United States
(12) Patent Application Publication
(10) Pub. No.: US 2018/0089681 A1
(43) Pub. Date: Mar. 29, 2018

(54) SYSTEM AND METHOD FOR COMPLIANCE SCREENING

(71) Applicants: Marie Fenimore, Wilmington, DE (US); Greg Kozub, Wilmington, DE (US)

(72) Inventors: Marie Fenimore, Wilmington, DE (US); Greg Kozub, Wilmington, DE (US)

(21) Appl. No.: 15/277,110

(22) Filed: Sep. 27, 2016

(51) Int. Cl. G06Q 20/40; G06F 17/30

(52) U.S. Cl. CPC G06Q 20/4016; G06F 17/30345

(57) ABSTRACT

A method includes accessing customer records database that includes screening records for each customer and each contact; redirecting, by the messaging service and to an external database engine, customer and contact information due for screening; in response to receiving, in a manner coordinated by the messaging service, results of likely sanctioned entities, (i) adjusting, through the messaging system, a manner in which on-going electronic transactions with the likely sanctioned entities are being processed such that the on-going electronic transactions are automatically and instantaneously suspended; and (ii) maintaining, by the messaging service, the customer records database such that the screening status of those customers or contacts for which screening has just been completed are updated, wherein the likely sanctioned entities corresponding to customers or contacts that substantial matches a sanctioned entity.

### BACKGROUND

Corporative entities must comply with trade regulations that prohibit business from dealings with unwanted entities and persons.

### SUMMARY

In one aspect, some implementations provide a computer-implemented method for maintaining a database customer records, the method including: accessing, by a messaging service and at an electronic customer records database, customer and contact information, the customer records database comprising screening records for each customer and each contact, each screening record indicating the screening status of a particular customer or a particular contact; redirecting, by the messaging service and to an external database engine, customer and contact information from those screening records that are due for screening, the external database engine regularly maintained by a third-party organization and comprising a list of entities currently sanctioned by a government authority; in response to receiving, in a manner coordinated by the messaging service, results of likely sanctioned entities after the customer and contact information from those screening records have been compared with the list of entities in the external database engine, (i) adjusting, through the messaging system, a manner in which on-going electronic transactions with the likely sanctioned entities are being processed such that the on-going electronic transactions are automatically and instantaneously suspended; and (ii) maintaining, by the messaging service, the customer records database such that the screening status of those customers or contacts for which screening has just been completed are updated, wherein the likely sanctioned entities corresponding to customers or contacts that substantial matches a sanctioned entity.

Implementations may include the following features.

Some implementations may include comprising in response to receiving results of likely sanctioned entities, soliciting, by the messaging service, additional scrutiny for the likely sanctioned entities to determine whether such likely sanctioned entities truly corresponds to one or more sanctioned entities. Some implementations may further include alerting the participant parties doing business with the likely sanctioned entities while additional scrutiny is being applied to determine whether such likely sanctioned entities truly corresponds to one or more sanctioned entities.

In some implementations, maintaining the customer records database may include: flagging, in a customer relationship database, the particular customer or contact of the likely sanctioned entity as blocked.

Some implementations may further include: in response to receiving determination results from the additional scrutiny, updating the customer records database to flag the customers or records of the likely sanctioned entities as false positives. Some implementations may further include: flagging the customers or records of the likely sanctioned entities as false positives such that when subsequently identified likely sanctioned entities are compared with the false positive records to reduce incidence of false positives.

Some implementations may include: reorganizing, by the messaging service, the screening records to accommodate incremental changes on a routine basis and subsequently uploading to the external database engine, the reorganized screening records; in response to receiving results of likely sanctioned entities that are returned upon completion in a manner coordinated by the messaging service when the reorganized screening records have been compared with the list of entities in the external database engine, (i) flagging, by the messaging service, the likely sanctioned entities for additional scrutiny to determine whether such likely sanctioned entities truly corresponds to one or more sanctioned entities; (ii) alerting, through the messaging system, participant parties doing business with each likely sanctioned entities while additional scrutiny is being applied to determine whether such likely sanctioned entities truly corresponds to one or more sanctioned entities; and (iii) maintaining the customer records database such that the screening status of those customers or contacts from the reorganized screening records for which screening has just completed screening are updated.

Some implementations may include: presenting a user interface such that a relationship between a customer or contact in the customer records database is analyzed against a sanctioned entity. In some implementations, the user interface is configured to construct a Simple Object Access Protocol (SOAP) message that assembles information of each customer and contact under review and the corresponding information of the sanctioned entity such that the customer records database is updated in a manner that is ACID (Atomicity, Consistency, Isolation, Durability). Some implementations may further include: transferring results of analysis from the user interface when information of each customer and contact under review and corresponding information of each customer and contact of the sanctioned entity have been analyzed.

In some implementations, maintaining the database system may include: updating the customer records database by storing data based on the received results through object mappings to synchronize each field of information specific to a sanctioned entity with comparable field of the customer or contact in the customer records database.

In some implementations, causing the customer and contact information from those screening records to be compared with the list of entities in the external database engine may include: causing the customer and contact information from those screening records to be compared with the list of entities in the external database engine according to a fuzzy logic.

Some implementations may include: receiving supplemental results indicating entities to be placed on the sanctioned list, the entities not included in the results of likely sanctioned entities which have been received via the messaging service; alerting, through the messaging system, participant parties doing business with each entity from the supplemental results such that transactions with each entity from the supplemental results are automatically and instantaneously suspended.

In another aspect, some implementations provide a computer system that includes a database system of records and at least one processor coupled to the database system. The processor is configured to perform the operations of: accessing, by a messaging service and at an electronic customer records database, customer and contact information, the customer records database comprising screening records for each customer and each contact, each screening record indicating the screening status of a particular customer or a particular contact; redirecting, by the messaging service and to an external database engine, customer and contact information from those screening records that are due for screening, the external database engine regularly maintained by a third-party organization and comprising a list of entities currently sanctioned by a government authority; in response to receiving, in a manner coordinated by the messaging service, results of likely sanctioned entities after the customer and contact information from those screening records have been compared with the list of entities in the external database engine, (i) adjusting, through the messaging system, a manner in which on-going electronic transactions with the likely sanctioned entities are being processed such that the on-going electronic transactions are automatically and instantaneously suspended; and (ii) maintaining, by the messaging service, the customer records database such that the screening status of those customers or contacts for which screening has just been completed are updated, wherein the likely sanctioned entities corresponding to customers or contacts that substantial matches a sanctioned entity.

Implementations may include the following features.

In some implementations, the processor may be configured to perform the operation of: in response to receiving results of likely sanctioned entities, soliciting, by the messaging service, additional scrutiny for the likely sanctioned entities to determine whether such likely sanctioned entities truly corresponds to one or more sanctioned entities.

In some implementations, the processor may be configured to perform the operation of alerting the participant parties doing business with the likely sanctioned entities while additional scrutiny is being applied to determine whether such likely sanctioned entities truly corresponds to one or more sanctioned entities.

In some implementations, the processor may be configured to maintain the customer records database by: flagging, in a customer relationship database, the particular customer or contact of the likely sanctioned entity as blocked. In some implementations, the processor may be configured to perform the operation of: in response to receiving determination results from the additional scrutiny, updating the customer records database to flag the customers or records of the likely sanctioned entities as false positives. In some implementations, flagging the customers or records of the likely sanctioned entities as false positives may be performed such that when subsequently identified likely sanctioned entities are compared with the false positive records to reduce incidence of false positives.

In some implementations, the processor may be configured to perform the operation of: reorganizing, by the messaging service, the screening records to accommodate incremental changes on a routine basis and subsequently uploading to the external database engine, the reorganized screening records; in response to receiving results of likely sanctioned entities that are returned upon completion in a manner coordinated by the messaging service when the reorganized screening records have been compared with the list of entities in the external database engine, (i) flagging, by the messaging service, the likely sanctioned entities for additional scrutiny to determine whether such likely sanctioned entities truly corresponds to one or more sanctioned entities; (ii) alerting, through the messaging system, participant parties doing business with each likely sanctioned entities while additional scrutiny is being applied to determine whether such likely sanctioned entities truly corresponds to one or more sanctioned entities; and (iii) maintaining the customer records database such that the screening status of those customers or contacts from the reorganized screening records for which screening has just been completed are updated.

In some implementations, the processor may be configured to perform the operation of: presenting a user interface such that a relationship between a customer or contact in the customer records database is analyzed against a sanctioned entity. In some implementations, the user interface may be configured to construct a Simple Object Access Protocol (SOAP) message that assembles information of each customer and contact under review and the corresponding information of the sanctioned entity such that the customer records database is updated in a manner that is ACID (Atomicity, Consistency, Isolation, Durability). In some implementations, the processor may be configured to perform the operation of: transferring results of analysis from the user interface when information of each customer and contact under review and corresponding information of each customer and contact of the sanctioned entity have been analyzed.

In some implementations, the processor may be configured to perform the operation of maintaining the database system by: updating the customer records database by storing data based on the received results through object mappings to synchronize each field of information specific to a sanctioned entity with comparable field of the customer or contact in the customer records database.

In some implementations, the processor may be configured to perform the operation of: transferring results of analysis from the user interface when information of each customer and contact under review and corresponding information of each customer and contact of the sanctioned entity have been analyzed.

In some implementations, the processor may be configured to perform the operation of maintaining the database system by: updating the customer records database by storing data based on the received results through object mappings to synchronize each field of information specific to a sanctioned entity with comparable field of the customer or contact in the customer records database.

In yet another aspect, some implementations provide a computer-readable medium that includes software instructions that, when executed by a computer coupled to a database system of records, causes the computer to perform the operations of: accessing, by a messaging service and at an electronic customer records database, customer and contact information, the customer records database comprising screening records for each customer and each contact, each screening record indicating the screening status of a particular customer or a particular contact; redirecting, by the messaging service and to an external database engine, customer and contact information from those screening records that are due for screening, the external database engine regularly maintained by a third-party organization and comprising a list of entities currently sanctioned by a government authority; in response to receiving, in a manner coordinated by the messaging service, results of likely sanctioned entities after the customer and contact information from those screening records have been compared with the list of entities in the external database engine, (i) adjusting, through the messaging system, a manner in which on-going electronic transactions with the likely sanctioned entities are being processed such that the on-going electronic transactions are automatically and instantaneously suspended; and (ii) maintaining, by the messaging service, the customer records database such that the screening status of those customers or contacts for which screening has just been completed are updated, wherein the likely sanctioned entities corresponding to customers or contacts that substantial matches a sanctioned entity.

The details of one or more aspects of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 is a sequence diagram illustrating an example of customer compliance check solution design.

FIG. 2A is a sequence diagram illustrating an example of automatically queued customer compliance check processing.

FIG. 2B is a sequence diagram illustrating an example of central records repository communicating with Customer Data Hub through an automatic messaging system.

FIG. 2C shows a sequence diagram illustrating additional details in the example of FIG. 2B.

FIG. 2D shows a sequence diagram illustrating additional details in the example of FIG. 2C

FIG. 2E is a sequence diagram illustrating an example of workroom operation flow based on the examples from FIG. 1 and FIGS. 2A-2D.

FIG. 3 is a flow chart showing an example of a compliance check for corporative entities.

### DETAILED DESCRIPTION

Detecting illicit electronic transactions are a computationally burdensome task. The problem is made even more pronounced as filtering systems are often required to filter for a “needle-in-a-haystack” as the overall proportion of suspect transactions may be quite low. In some cases, the number of “hits” may be on the order less than one per million or a few instances in a whole year. In one example, a corporate entity may be trying to comply with treasury and/or trade regulations that prohibit business from dealings with unwanted entities and persons. Among other requirements, US regulations prohibit corporative entities from doing business in any form with terrorists, narcotics traffickers, major criminals, people residing in sanctioned countries, and those associated with sanctioned programs. There can be no de minimis exception to the compliance requirements under Office of Foreign Assets Control (OFAC). Failure to conduct due diligence checks may trigger adverse consequences. For example, failure to comply may result in reputational risk in addition to steep fines, and harsh penalties. Therefore, filtering systems must administer a rigorous check against voluminous records that are being updated constantly as well as a diligent maintenance of internal customer relationship management database that includes to monitor and triage on-going transactions regarding all customers and contacts. Computationally, the task is burdensome to process the sheer number of records at such a low ratio of matches. Further, the task may be burdensome as the filtering action may be performed on multiple systems that process an individual matter across a sequence of substeps involving disparate, and sometimes heterogeneous systems.

Systems and methods disclosed herein provide computer-assisted record checking at a variety of databases in an exhaustive manner with the underlying databases being updated and maintained to reflect timely intelligence while also reducing the likelihood of false positives. Comprehensive datasets from different and sometimes incompatible databases may be processed in order to generate real-time messages, which are then automatically reported to an administrator as well as being seamlessly used by other databases used to enforce filtering criteria. In particular, an automatic messaging system can interoperate with various database systems to provide expeditious lead information that drives subsequent actions based on information from the corporate's internal customer relationship management (CRM) database. For example, the automatic messaging system can suspend or halt on-going transactions with suspicious entities instantaneously without operator input. In contrast to a naïve solution that uploads a massive volume of information to an external database, the automatic messaging provides a glue to integrate various external database systems with internal CRM databases such that customer and contact information are routinely checked against the most current information on the external database systems and the results are used to drive internal CRM databases so that on-going transactions with suspicious entities can be instantaneously suspended or halted while internal stake-holders involved in the transactions can be automatically alerted. The suspension or halt can be effectuated upon the return of such results. This instantaneous feature is realized automatically without user intervention. The lead information can be displayed on a range of end-user devices so that a human operator can pick up the lead information and conduct in-depth review. The searches conducted at one or more databases may incorporate a fuzzy logic to identify entity names that are not exactly identical but bear substantial resemblance. The match results may factor in a score generated based on the degree of matches. Feedback from operator analysis can be looped back to the fuzzy logic so that the incidence of false positives can be reduced further. Moreover, ad hoc cases may introduce otherwise unsanctioned entities into the system such that the corporation may be alerted through a messaging system to automatically cease or suspend all on-going transactions with these entities.

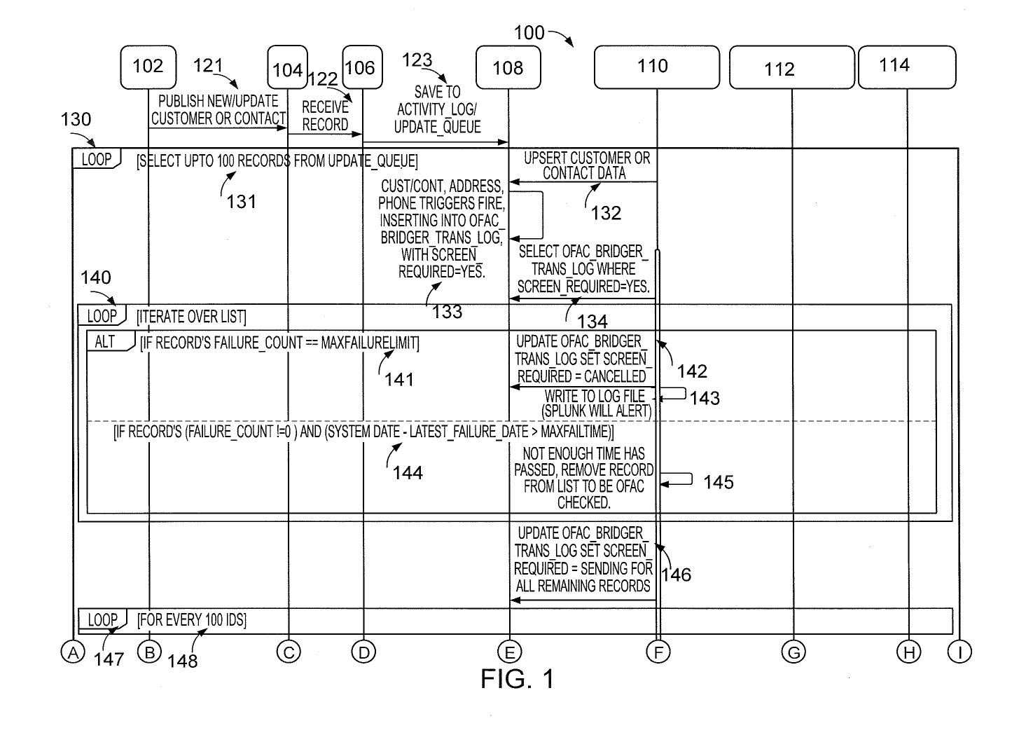

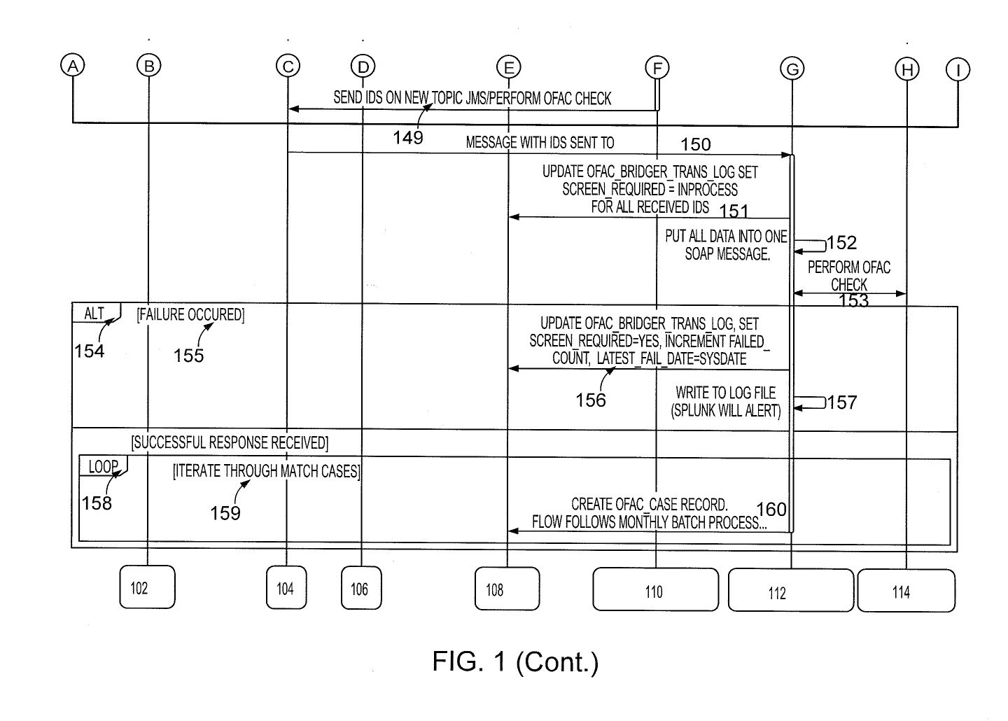

FIG. 1 is a sequence diagram 100 illustrating an example of customer compliance check solution. Company Records/Customer Master (CR/CM) 102 refers to database of all customers and contacts in the CR/CM database of the company. This may generally refer to all forms of customers and contacts in a customer relationship management (CRM) database showing customers that has business dealings with the company holding such CRM database. These customers may include parties being invoiced as recipient of goods or services, or parties that are expected to invoice the company for providing goods or rendering services. Each customer may include one or more contacts for such business dealings. CR/CM 102 may be published or updated with new customers or contact. Moreover, information on contacts, customers, and reseller can be processed for compliance checks.

A customer or contact may be identified as matching an entity on the sanctioned list provided by a central records repository. One example of the central records repository can include a Bridgerinsight database from LexisNexis. The match can include an exact match, or a substantial match (e.g., Mary v. Marie). In general, a match is subject to human verification. If a match is found, automatic processes are in place to label the customer or contact as “BLOCKED,” stop the processing of transactions for BLOCKED customers and contacts, and notify business lines doing business with the BLOCKED customers and contacts. Customers and contacts are blocked independently of each other. If a contact is blocked, only work for that contact is blocked. If a customer is blocked, all work is stopped for that customer. Further, automatic processing may identify pending activities for BLOCKED customers or contacts. Pending activities should be paused so that nothing gets shipped, sent, or provided for the customer or contact. This pause applies to, without limitation, orders, invoices, order fulfillment, cash receipts, collections, standard operating procedures (SOP), subscription renewals, etc. In particular, orders shouldn't be cancelled, invoices credited. Account Receivable written off, etc. In some implementations, the CRM database (e.g., Salesforce) is updated accordingly to reflect the parties (e.g., customer or contact) being blocked and activities being suspended. While activities are paused, human operator, for example, legal personnel will give direction on how to proceed after an inventory of all activity is collected.

Newly created customers and contacts will be checked, for example, within minutes of entry. CR/CM customers or contacts that have a name, address or phone change will be checked, for example, within minutes. In the example of the IPM records, such information may be checked, for example, on a daily basis.

In more detail, the new or updated customer or contact information, as published, may enter a messaging service 104 so that the updates or new publications are communicated as message passing queues (121). The communication can be asynchronous or synchronous. In some instances, messaging service 104 is configured as a Java Message Service. The example JMS system can interoperate with a variety of incoming queues by incorporating a Java Message Oriented Middleware (MOM) API for sending messages between two end points. The example APIs are featured to use a publish-and-subscribe model such that new publications and updates are streamed as messages flowing into message service 104. In this manner, information from the incoming queue can be automatically and seamlessly coupled to listening threads. The JMS message queue is a high-performance and highly concurrent load balancer capable of handling large throughput such that thousands or more messages can be sent per second to many processes and threads. As detailed further, the messaging service may integrate with monthly scans conducted at one or more third-party database systems such that results of the scans may feed automatically and seamlessly into subscribers listening on the results. In this manner, on-going transactions with the identified entities may be halted or suspended instantaneously. In a similar fashion, business units within the corporation conducting business with the identified entities can be alerted right away.

In this example, the messaging service 104 translates database information from CM/CR 102 into messages for distribution to Customer Data Hub (CDH) 106. As an illustrative example, the CM/CR 102 database entry information can be parsed and queued as email messages in a streaming manner directed at CDH 106. The stream of records may thus be received at CDH 106 (122). CDH 106 may then save the received records as activity log or update queue on database (DB) 108.

In an example, loop 130 shows a queue update process. In one example, up to 100 records may be selected from update queue. UpdateQueue Process 110 can upload and insert customer or contact data into the records holding place on DB 108 (132). The updated entries may include customer contact, address, and phone information. In this example, the entries may trigger a field SCREEN_REQUIRED in a transaction log to be set as YES so that these entries will be automatically screened against the system of record at a central records repository (133). The UpdateQueue Process 110 may select entries from the transaction log that has the field SCREEN_REQUIRED set as YES for screening at central records repository (134).

Loop 140 is another example of iterating over the list of entries in a transaction log file. In an example of alternative branch 141, if the record's failure count is set to a maximum number, then the transaction log for the particular records may have the field SCREEN_REQUIRED set to CANCELLED (142). While this update is being written to the transaction log, an intelligence software agent adapted for handling such machine generated data may generate an alert. In some instances, the alert may be sent to, for example, human operators to make them aware of the cancelled entries (143). The alert for human intervention can be realized by using various third party systems, such as for example, event recording systems which ingest log files and then message subscribing systems when trigger conditions are met.

In this example, if records has a non-zero failure count and the duration since the last failure has not passed a threshold date/time (144), then insufficient amount of time has passed and the record may be removed from the list for screening at central records repository for compliance check (145). Thereafter, the transaction log may be updated to set the field SCREEN_REQUIRED to SENDING for all remaining records.

In yet another example of loop 147, for every 100 identity records, UpdateQueue Process 110 sends the batch of identity records to messaging service 104 (149). The messaging service 104 may then route the messages with the identity records to a check service 112 (150). The check service may then update the transaction log such that field for SCREEN_REQUIRED is set to INPROGRESS for all received identity records (151). The check service (112) may then formulate one message to encapsulate all identity records data (152). In some instances, the check service may construct one Simple Object Access Protocol (SOAP) message, for example, using extendable markup language (XML). The XML used to make requests and receive responses in SOAP is highly flexible. It can be written with the help of tools of, for example, Web Services Description Language (WSDL) which provides a definition of the operative aspect of the web service so that objects can be created by reference. SOAP may be used other than the HyperText Transfer Protocol (HTTP) transport. Indeed, SOAP can be used over Simple Mail Transfer Protocol (SMTP). In some implementations, the SOAP message may be advantageously submitted to the central records repository for compliance check in a manner that is ACID (Atomicity, Consistency, Isolation, Durability) compliant for database transactions. In some instances, the central records repository includes a Bridgerinsight database.

In the example of alternative branch 154, failure has occurred in which access or communication to the central records repository becomes unavailable (155). Here, the check service updates the transaction log to reflect that for the affected records which require screening at the central records repository, their failure count is incremented, and their last failure date is stamped and recorded (156). The check service 112 may then write the update to the transaction log (157). While this update is being written to the transaction log, an intelligence software agent, such as a Splunk agent, adapted for handling such machine generated data may generate an alert. In some instances, the alert may be sent to, for example, human operators to make them aware of the failed communications for related records.

In the example of loop 158, when responses are successfully received from the central records repository 114, some implementations may iterate through matching cases. In these implementations, check service 112 may create a case record, for example, an Office of Foreign Assets Control (OFAC) case record, indicating a potential match for a sanctioned entity (160).

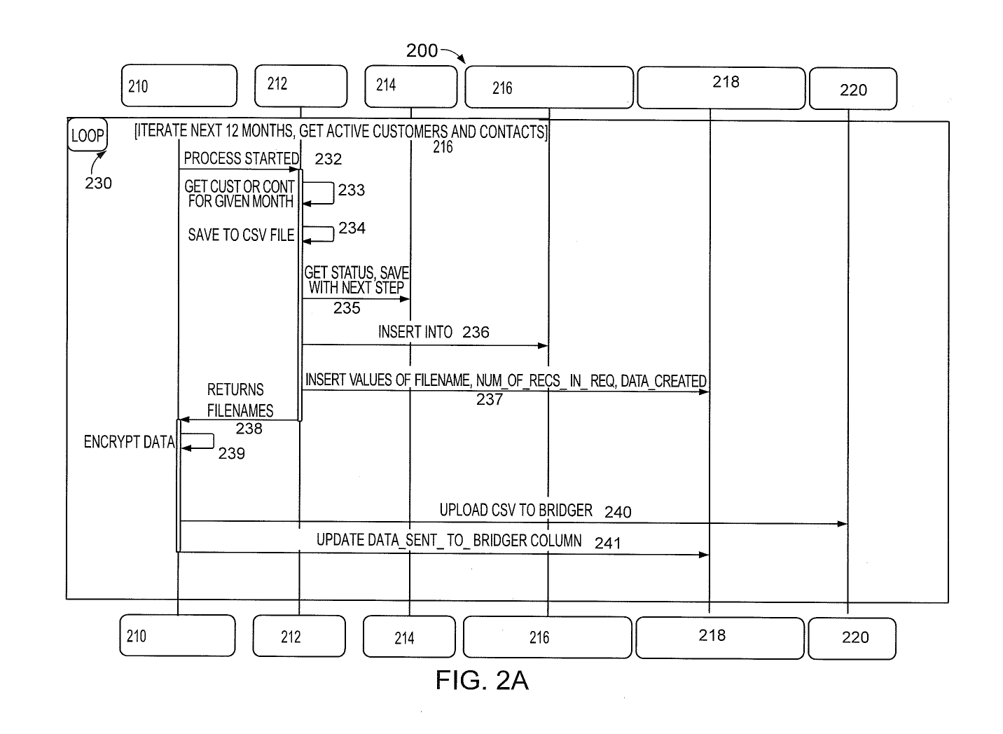

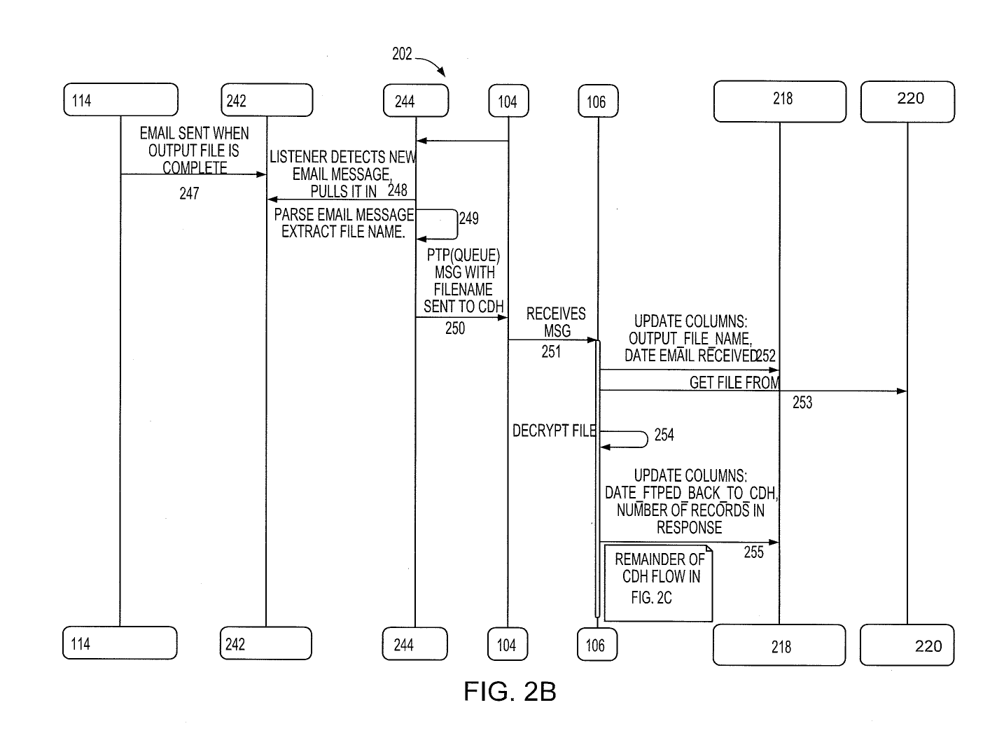

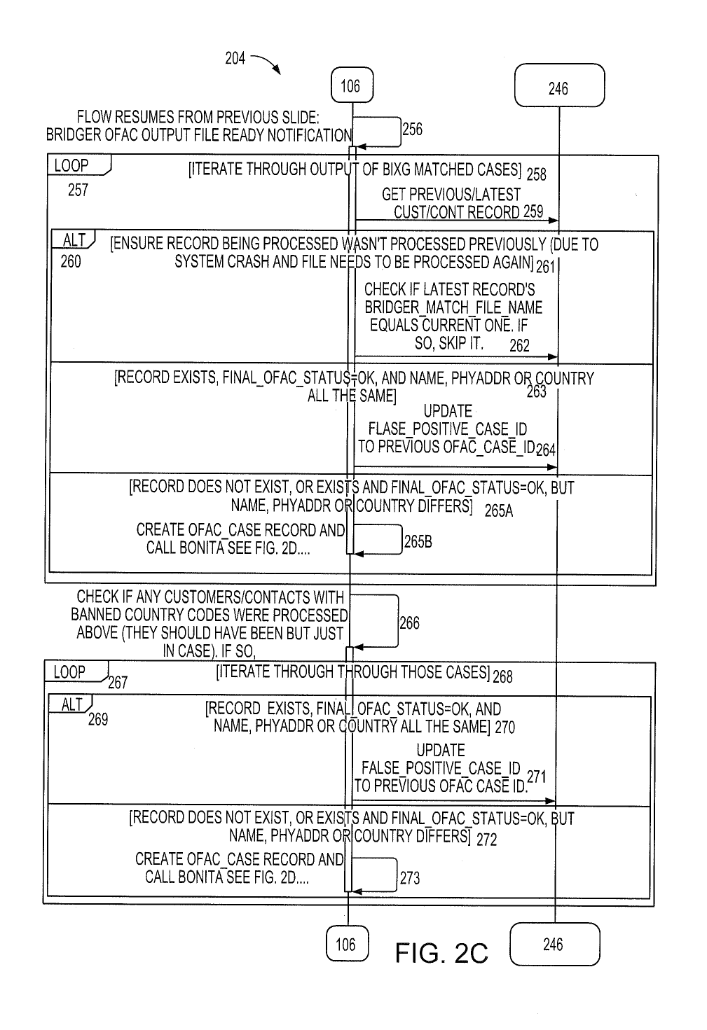

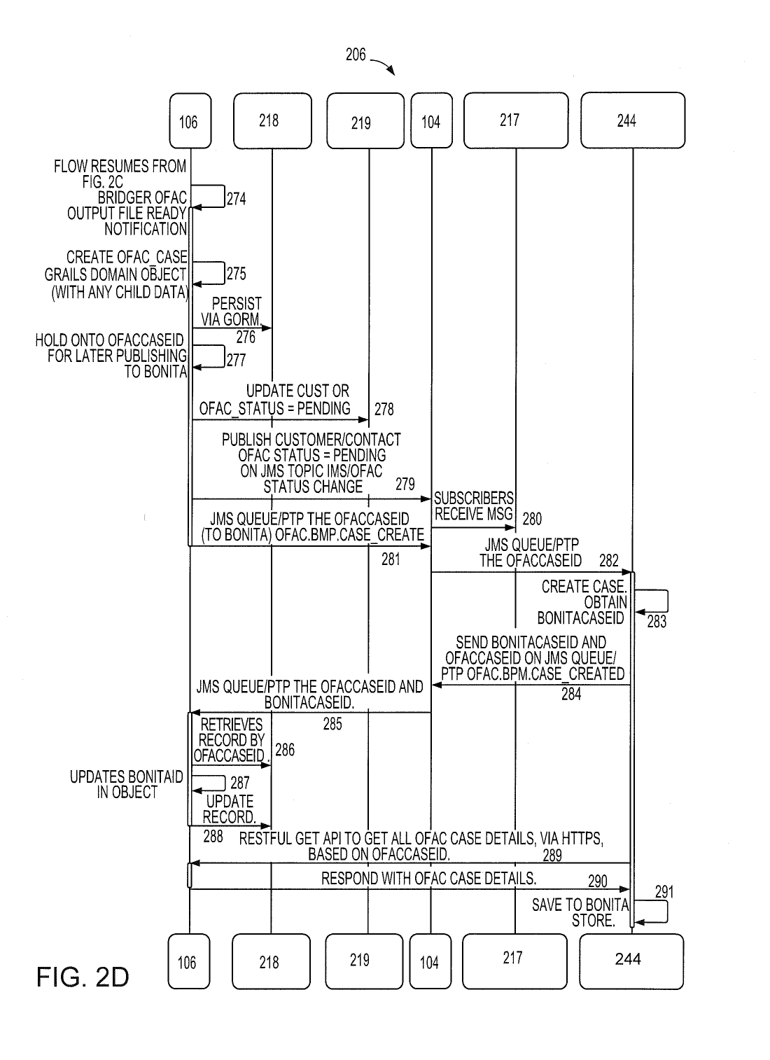

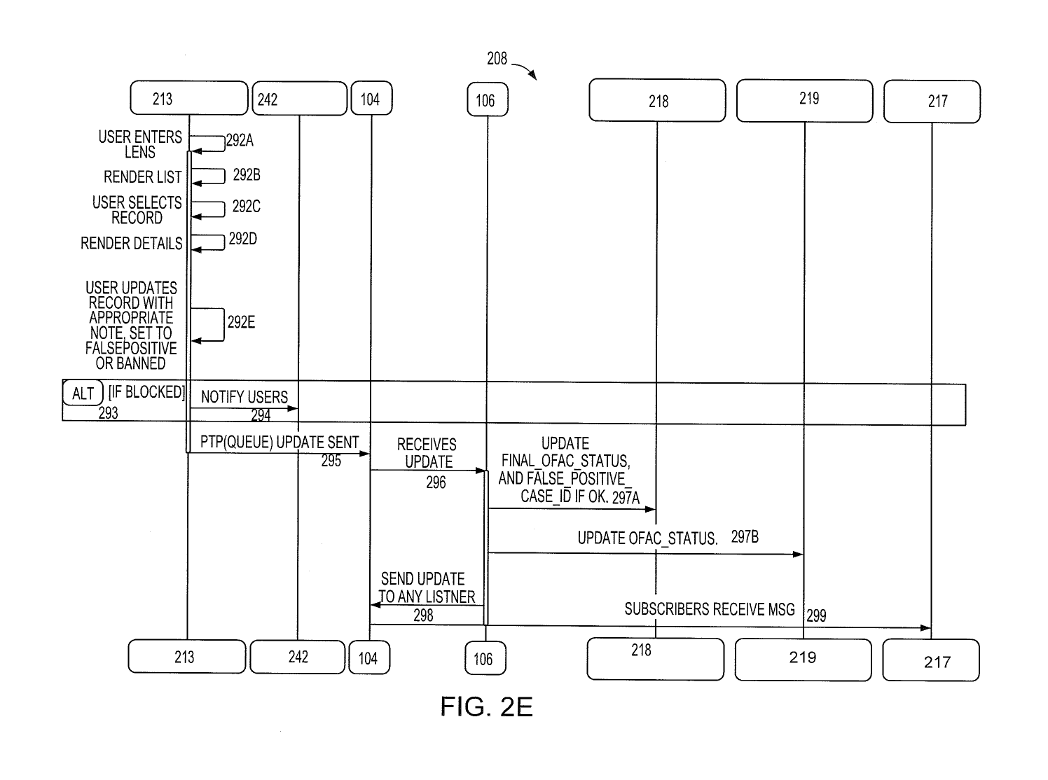

Subsequently, all customers and contact information in CR/CM 102 may be checked, for example, on a monthly basis. In some instances, work flow may follow, for example, a monthly schedule as discussed in FIGS. 2A to 2E.

FIG. 2A is a sequence diagram 200 illustrating an example of monthly job request creation process. The monthly job request 210 may be implemented as a thread. In some instances, database process 212 is an Oracle process launched on an Oracle database server. For illustration, a loop 230 may run iteratively each month for 12 months to collect active customers and contacts (231). Database process 214, database train log process 216, database log 218 and central records repository FTP server may operate to receive messages and information from database process 212.

The creation process may start when a job request is received at database process 212 (232). Database process 212 may be a master thread waiting for an incoming job request. At the arrival of an incoming job request, the master thread may fork or spawn one or more dedicated processing threads. In this illustration, the processing threads may get information of customer or contact for the given month (233). The information may be parsed into a regularized format and the saved as to file, for example, a comma separated value (CSV) file (234) so that the information of customer and contact for screening is in persistent storage.

In some instances, from database process 212, a database for country information 214 may get status information, which is then saved (235). In some instances, a database transaction log 214 may download parsed information from database process 212 so that such information is inserted into the database training log (236). Similarly, database process 212 may cause values of filename, number of records in the request for screening, and information of customer and contact to be inserted into database log 218 (237).

Database process 212 may return file names, for example, of the saved CSV file to job request thread 210 (238). Job request thread 210 may then encrypt data that encode customers and contacts information (239). The encrypted data may then be uploaded to central records repository 220 (240), for example, in a CSV format. Subsequently, a relevant flag can be set on database log 218 to indicate that the monthly data has been sent to central records repository (241).

FIG. 2B is a sequence diagram 202 illustrating an example of central records repository communicating with Customer Data Hub through an automatic messaging system. When central records repository 114 wraps up processing the submitted customers and contacts, it may generate and send an email to an email server 242 (247). The email message may contain the filename for the processed results. The messaging service 104 may communicate with a Business Process Management (BPM) module 244. BPM module 244 may use a mail service to listen in at the email server and detect the new incoming message (248). Upon detection, BPM module 244 may parse the email message and extract the filename therefrom (249). BPM module may then send a peer-to-peer (P2P) queue message (e.g., JMS message) with the extracted filename to CDH 106 (251). CDH 106 may then receive the message (251). CDH 106 may subsequently update database transaction log 218 to reflect the newly received filename and receipt time of the email (252). CDH 106 may then get the file from central records repository. In some cases, the file may be retrieved from a FTP server 220 of the central records repository (253). CDH 106 may decrypt the contents of the newly retrieved file (254). CDH 106 may then update the database transaction log 218 to reflect the time of receiving the file and the number of records in the received file.

FIG. 2C shows a sequence diagram 204 illustrating additional details in the example of FIG. 2B. CDH 106 may be notified that the output file is ready and has been retrieved (256). In the example of loop 257, the process may iterate through earlier identified matching cases (258) by getting previous or latest customer/contact record from database of earlier cases 246 (259). In an alternative branch 260, CDH 106 confirms that the record being processed was not processed earlier (261). In certain conditions (e.g., system crash), records may need to be processed again. For example, CDH 106 may check if latest record's filename equals to the current one. If so, processing may be skipped (262). If matching record exists with an OK final status and speaks to the same name, physical address and country, then CDH 106 may update false positive ID to indicate that the matching record may be a false positive record (264). Here, the record refers to an earlier record that has been inspected by a human operator. If the earlier record does not exist, or the earlier record exists with an OK final status but speak to different name, physical address and country, CDH 106 may create a new OFAC case record for manual review and proceed to FIG. 2D (265).

CDH 106 may further check if any customers/contacts with banned country codes were processed above (266). If so, CDH 106 may start loop 267 to iterate through those cases (268). In an example of an alternative branch 269, if the record exists with an OK final check status and speaks to the same speaks to the same name, physical address and country (270), then CDH 106 may update false positive ID to indicate that the matching record may be a false positive record (271). If the earlier record does not exist, or the earlier record exists with an OK final status but speak to different name, physical address and country, CDH 106 may create a new OFAC case record for manual review and proceed to FIG. 2D (273).

FIG. 2D shows a sequence diagram 206 illustrating additional details in the example of FIG. 2C. CDH 106 may be notified that the output file is ready and has been retrieved (274). In response, CDH 106 may create an OFAC case record for manual review. In one example, this created OFAC case record may include a grails domain object for object relationship mapping. The grails domain object may be loaded with child data (275). In this example, the object may then be persisted to storage on DB 218 (276). CDH 106 may hold onto the newly created OFAC case record ID for later publishing to BPM module 244 (277). CDH 106 may then update information at DB for customer and contact 219 so that the OFAC status for such customer or contact is updated to pending review (278). CDH 106 may then publish customer or contact that has an OFAC status of pending review at messaging service 104 (279). Participants, such as various business lines, may subscribe to the publication service of the messaging service 104 such that the participants receives the publications in a streaming manner (280). The participants thus become notified of the pending review of certain customers or contacts. In some instances, all business dealings with these customers or contacts may be suspended while further review is being conducted to determine whether these customers or contacts are indeed on the sanctioned list of the OFAC. In other instances, only unshipped items or unpaid invoices are suspended in the interim. Such suspensions are determined on a case by case basis. The suspensions are put in place once the results arrive regardless of the actual arrival time. In other words, the suspension may operate solely by pre-configured machine logic and without user intervention that could slow down the suspension. Meanwhile, in all these instances, CDH 106 may generate a message queue to transmit to the messaging service 104, in a peer-to-peer communication, information of the newly created OFAC case record ID (281). Thereafter, the messaging service 104 may feed this message queue with the OFAC case record ID to BPM module 244 (282). Subsequently, the BPM module 244 may create the OFAC case and obtain a BPM case ID (283). The BPM module 244 may then send the BPM case ID and OFAC case ID to the messaging service 104 (284) such that such information becomes available to CDH 106 as it listens in on the messaging service 104 (285). CDH 106 may then retrieve record from database 218 by the OFAC case ID (286). CDH 106 may then update BPM ID in an object for the customer or contact (287). CDH 106 may then update the records database 218 (288). Thereafter, BPM module 244 may get all OFAC case details from CDH 106 (289). The retrieval may be through hypertext transmittal protocol secure (HTTPS) based on the OFAC case ID. The retrieval operation may be through a RESTful (Representative State Transfer) API in which BPM module 244 may retrieve OFAC case details from CDH 106 (290).

FIG. 2E is a sequence diagram 208 illustrating an example of workroom operation flow based on the examples from FIG. 1 and FIGS. 2A-2D. Workroom 213 refers to a console or interface for user input. User may enter length of record (292A). The list may be rendered on the console (292B). User may then select record (292C). The console may render case details (292D). User may also update record with appropriate note, for example, flagging false positive matches or banned entries (292E). In an example of an alternative branch 293, when there is a blocked entry of a customer or contact, an email message may be formulated and sent to email server 242 to notify business personnel who need to be know this issue (294). Workroom 213 may also generate a peer-to-peer queue update and send it to messaging service 104 (295). CDH 106, by subscribing to messaging service 104, receives the update (296). Subsequently, CDH 106 may update the final OFAC status of the customer or contact in database 218 (297A). The update may switch the final OFAC status to indicate it is a false positive. CDH 106 may also update the OFAC status of the customer or contact in the database for customer or contact 219 (297B). CDH 106 may also send an update to messaging service 104 (298) so that all listeners can receive the update as subscribers to receive message from messaging service 104 (299).

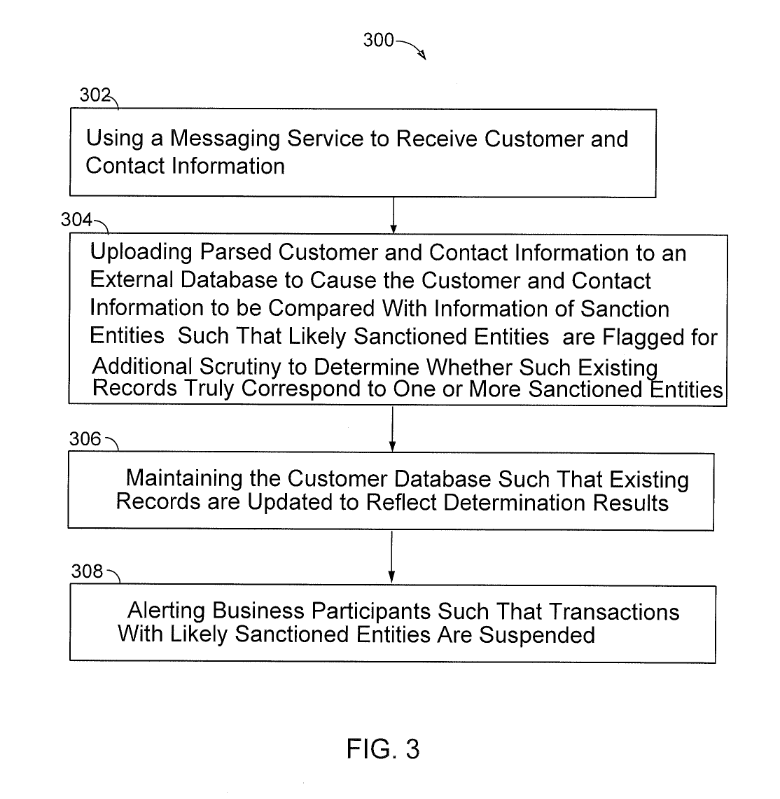

FIG. 3 is a flow chart 300 showing an example of a compliance check for corporative entities. Initially, customer and contact information is received through a messaging service (302). The customer and contact information may be received from a customer relationship management database, such as CR/CM 102. The messaging service may include messaging service 104. In one example, a customer records database such as database at CDH 106 is updated with the received customer and contact information. In this example, the customer records database includes screening records for each customer and each contact and each screening record indicates the screening status of a particular customer or a particular contact.

Subsequently, customer and contact information from those screening records that are due for screening are uploaded to an external database engine (304). In one example, the external database engine is BridgerInsight server 246. The external database engine is regularly maintained by a third-party organization and includes a list of entities currently sanctioned by a government authority.

The customer and contact information from those screening records are subsequently compared with the list of entities in the external database such that results of likely sanctioned entities are returned upon completion (306). The match may leverage a taxonomy and a set of linguistic rules. The taxonomy may be laid out in, for example, a resource description framework (RDF) language. A SPARQL Protocol and RDF Query Language (SPARQL) may be used to retrieve or manipulate data stored in the RDF format. In addition to RDF, the definitions of classes, properties and the relationships (sometimes referred to as the schemas) between the classes or properties, may also be specified according to a web ontology language (OWL). The set of linguistic rules may also include rules for matching term, phrases, patterns, etc. For example, the set of linguistic rules may assign a weight for each matching term, each matching phrase, and each matching pattern. For example, if the matching terms occur within the same sentence, the assigned weight may be higher than if the matching terms occur with less proximity (for example, within the same paragraph, etc.). In some configurations, a proximity-dependent weighting may assign more weight if the matching terms are separated by fewer words. Moreover, the linguistic rule may include an additional weight to indicate how likely the postings may be relevant to a foreign entity. Numerical weighting may quantify a score and the score may be compared against a threshold. The threshold may function as a cut-off level to weed out less likely matches. Based on the ontology as well as the linguistic rules, text mining may be performed to extract results from an ocean of customer and contact information.

In one example, the messaging service coordinates the return. In this example, when automatic screening is done, the external database engine signals the messaging service so that CDH 106, by listening to the messaging service, becomes aware of the completion and automatically communicates with the external database engine to fetch the results. Here, the results refer to the likely sanctioned entities that correspond to customers or contacts that substantial matches a sanctioned entity. The likely sanctioned entities are flagged for additional scrutiny to determine whether such likely sanctioned entities truly corresponds to one or more sanctioned entities. The additional scrutiny may include human operator analysis. More particularly, the returned results containing likely entities may trigger an alert, through the messaging service, to human operators, for example, legal analysts. The human operators render the determination in which false positives can be determined.

In some instances, cases can be created without result from the search indicating a hit at the external database. For example, cases may be created in an ad-hoc manner to target entities that should be blacklisted. For example, some entities may have ties to a sanctioned entity, for example, known to be funded by a sanctioned entity, but had not been officially listed as a sanctioned entity. These created cases may enable an operator to triage target entities so that information is yielded to supplement search results from the external database.

The customer records database is maintained such that the screening status of those customers or contacts that have just completed screening are updated (306). In more detail, those with completed scan as of the current date are now labelled accordingly. For implementations that enforce monthly scans, the timestamp serves as an indication of last scan. Those determined as false positives are labelled accordingly so that when later matching results of the same customer or contact are returned, the results may be determined based on the false negative labels. Those identified as sanctioned entities (either through the search results or through the supplemental results) may have their status updated. Through the messaging service, this status update may alert downstream processes and business stakeholders.

Through the messaging service, business stakeholders that participate in the business dealings with likely sanctioned entities are alerted (308). In some instances when the degree of match is strong, or the likely sanctioned entities relate to specific foreign entities, all business dealings with the likely sanctioned entities are suspended while additional analysis is performed. In some instances, the entries corresponding to the sanctioned entities in a customer relationship management (CRM) database are blocked.

Implementations of the subject matter and the functional operations described in this specification can be implemented in digital electronic circuitry, in tangibly-implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

1. A method for maintaining a database customer records, the method comprising:
accessing, by a messaging service and at an electronic customer records database, customer and contact information, the customer records database comprising screening records for each customer and each contact, each screening record indicating the screening status of a particular customer or a particular contact;
redirecting, by the messaging service and to an external database engine, customer and contact information from those screening records that are due for screening, the external database engine regularly maintained by a third-party organization and comprising a list of entities currently sanctioned by a government authority;
in response to receiving, in a manner coordinated by the messaging service, results of likely sanctioned entities after the customer and contact information from those screening records have been compared with the list of entities in the external database engine,
(i) adjusting, through the messaging system, a manner in which on-going electronic transactions with the likely sanctioned entities are being processed such that the on-going electronic transactions are automatically and instantaneously suspended; and
(ii) maintaining, by the messaging service, the customer records database such that the screening status of those customers or contacts for which screening has just been completed are updated,
wherein the likely sanctioned entities corresponding to customers or contacts that substantial matches a sanctioned entity.

2. The method of claim 1, further comprising in response to receiving results of likely sanctioned entities, soliciting, by the messaging service, additional scrutiny for the likely sanctioned entities to determine whether such likely sanctioned entities truly corresponds to one or more sanctioned entities.

3. The method of claim 2, further comprising:
alerting the participant parties doing business with the likely sanctioned entities while additional scrutiny is being applied to determine whether such likely sanctioned entities truly corresponds to one or more sanctioned entities.

4. The method of claim 1, wherein maintaining the customer records database further comprises:
flagging, in a customer relationship database, the particular customer or contact of the likely sanctioned entity as blocked.

5. The method of claim 2, further comprising:
in response to receiving determination results from the additional scrutiny, updating the customer records database to flag the customers or records of the likely sanctioned entities as false positives.

6. The method of claim 5, wherein flagging the customers or records of the likely sanctioned entities as false positives such that when subsequently identified likely sanctioned entities are compared with the false positive records to reduce incidence of false positives.

7. The method of claim 1, further comprising:
reorganizing, by the messaging service, the screening records to accommodate incremental changes on a routine basis and subsequently uploading to the external database engine, the reorganized screening records;
in response to receiving results of likely sanctioned entities that are returned upon completion in a manner coordinated by the messaging service when the reorganized screening records have been compared with the list of entities in the external database engine,
(i) flagging, by the messaging service, the likely sanctioned entities for additional scrutiny to determine whether such likely sanctioned entities truly corresponds to one or more sanctioned entities;
(ii) alerting, through the messaging system, participant parties doing business with each likely sanctioned entities while additional scrutiny is being applied to determine whether such likely sanctioned entities truly corresponds to one or more sanctioned entities; and
(iii) maintaining the customer records database such that the screening status of those customers or contacts from the reorganized screening records for which screening has just completed screening are updated.

8. The method of claim 1, further comprising:
presenting a user interface such that a relationship between a customer or contact in the customer records database is analyzed against a sanctioned entity.

9. The method of claim 8, wherein the user interface is configured to construct a Simple Object Access Protocol (SOAP) message that assembles information of each customer and contact under review and the corresponding information of the sanctioned entity such that the customer records database is updated in a manner that is ACID (Atomicity, Consistency, Isolation, Durability).

10. The method of claim 9, further comprising:
transferring results of analysis from the user interface when information of each customer and contact under review and corresponding information of each customer and contact of the sanctioned entity have been analyzed.

11. The method of claim 1, wherein maintaining the database system comprises:
updating the customer records database by storing data based on the received results through object mappings to synchronize each field of information specific to a sanctioned entity with comparable field of the customer or contact in the customer records database.

12. The method of claim 1, wherein causing the customer and contact information from those screening records to be compared with the list of entities in the external database engine comprises: causing the customer and contact information from those screening records to be compared with the list of entities in the external database engine according to a fuzzy logic.

13. The method of claim 1, further comprising:
receiving supplemental results indicating entities to be placed on the sanctioned list, the entities not included in the results of likely sanctioned entities which have been received via the messaging service;
alerting, through the messaging system, participant parties doing business with each entity from the supplemental results such that transactions with each entity from the supplemental results are automatically and instantaneously suspended.

14. A computer system comprising a database system of records and at least one processor coupled to the database system, the processor being configured to perform the operations of:
accessing, by a messaging service and at an electronic customer records database, customer and contact information, the customer records database comprising screening records for each customer and each contact, each screening record indicating the screening status of a particular customer or a particular contact;
redirecting, by the messaging service and to an external database engine, customer and contact information from those screening records that are due for screening, the external database engine regularly maintained by a third-party organization and comprising a list of entities currently sanctioned by a government authority;
in response to receiving, in a manner coordinated by the messaging service, results of likely sanctioned entities after the customer and contact information from those screening records have been compared with the list of entities in the external database engine,
(i) adjusting, through the messaging system, a manner in which on-going electronic transactions with the likely sanctioned entities are being processed such that the on-going electronic transactions are automatically and instantaneously suspended; and
(ii) maintaining, by the messaging service, the customer records database such that the screening status of those customers or contacts for which screening has just been completed are updated,
wherein the likely sanctioned entities corresponding to customers or contacts that substantial matches a sanctioned entity.

15. The database system of claim 14, wherein the processor is configured to perform the operation of: in response to receiving results of likely sanctioned entities, soliciting, by the messaging service, additional scrutiny for the likely sanctioned entities to determine whether such likely sanctioned entities truly corresponds to one or more sanctioned entities.

16. The database system of claim 15, wherein the processor is configured to perform the operation of alerting the participant parties doing business with the likely sanctioned entities while additional scrutiny is being applied to determine whether such likely sanctioned entities truly corresponds to one or more sanctioned entities.

17. The database system of claim 15, wherein the processor is configured to maintain the customer records database by:
flagging, in a customer relationship database, the particular customer or contact of the likely sanctioned entity as blocked.

18. The database system of claim 17, wherein the processor is configured to perform the operation of:
in response to receiving determination results from the additional scrutiny, updating the customer records database to flag the customers or records of the likely sanctioned entities as false positives.

19. The database system of claim 17, wherein flagging the customers or records of the likely sanctioned entities as false positives is performed such that when subsequently identified likely sanctioned entities are compared with the false positive records to reduce incidence of false positives.

20. The database system of claim 14, wherein the processor is configured to perform the operation of:
reorganizing, by the messaging service, the screening records to accommodate incremental changes on a routine basis and subsequently uploading to the external database engine, the reorganized screening records;
in response to receiving results of likely sanctioned entities that are returned upon completion in a manner coordinated by the messaging service when the reorganized screening records have been compared with the list of entities in the external database engine,
(i) flagging, by the messaging service, the likely sanctioned entities for additional scrutiny to determine whether such likely sanctioned entities truly corresponds to one or more sanctioned entities;
(ii) alerting, through the messaging system, participant parties doing business with each likely sanctioned entities while additional scrutiny is being applied to determine whether such likely sanctioned entities truly corresponds to one or more sanctioned entities; and
(iii) maintaining the customer records database such that the screening status of those customers or contacts from the reorganized screening records for which screening has just been completed are updated.

21. The database system of claim 14, wherein the processor is configured to perform the operation of:
presenting a user interface such that a relationship between a customer or contact in the customer records database is analyzed against a sanctioned entity.

22. The database system of claim 21, wherein the user interface is configured to construct a Simple Object Access Protocol (SOAP) message that assembles information of each customer and contact under review and the corresponding information of the sanctioned entity such that the customer records database is updated in a manner that is ACID (Atomicity, Consistency, Isolation, Durability).

23. The database system of claim 14, wherein the processor is configured to perform the operation of:
transferring results of analysis from the user interface when information of each customer and contact under review and corresponding information of each customer and contact of the sanctioned entity have been analyzed.

24. The database system of claim 14, wherein the processor is configured to perform the operation of maintaining the database system by:
updating the customer records database by storing data based on the received results through object mappings to synchronize each field of information specific to a sanctioned entity with comparable field of the customer or contact in the customer records database.

25. A computer-readable medium comprising software instructions that, when executed by a computer coupled to a database system of records, causes the computer to perform the operations of:
accessing, by a messaging service and at an electronic customer records database, customer and contact information, the customer records database comprising screening records for each customer and each contact, each screening record indicating the screening status of a particular customer or a particular contact;
redirecting, by the messaging service and to an external database engine, customer and contact information from those screening records that are due for screening, the external database engine regularly maintained by a third-party organization and comprising a list of entities currently sanctioned by a government authority;
in response to receiving, in a manner coordinated by the messaging service, results of likely sanctioned entities after the customer and contact information from those screening records have been compared with the list of entities in the external database engine,
(i) adjusting, through the messaging system, a manner in which on-going electronic transactions with the likely sanctioned entities are being processed such that the on-going electronic transactions are automatically and instantaneously suspended; and
(ii) maintaining, by the messaging service, the customer records database such that the screening status of those customers or contacts for which screening has just been completed are updated,
wherein the likely sanctioned entities corresponding to customers or contacts that substantial matches a sanctioned entity.
